(19) United States
(12) Patent Application Publication
(10) Pub. No.: US 2017/0144821 A1
(43) Pub. Date: May 25, 2017

(54) Package for Mushrooms, Fresh Fruits and Vegetables

(71) Applicant: INSTITUTO TECNOLOGICO DEL EMBALAJE, TRANSPORTE Y LOGISTICA (ITENE), Paterna (ES)

(72) Inventors: Ana Guadalupe GALET DOMINGO, Paterna (ES); Ana BELTRÁN SANAHUJA, Paterna (ES); Maria Rut JOVANI ABRIL, Paterna (ES); José Maria BERMÚDEZ SALDAÑA, Paterna (ES); Marta Inés LARA LLEDÓ, Paterna (ES); Susana AUCEJO ROMERO, Paterna (ES)

(21) Appl. No.: 15/422,094

(22) Filed: Feb. 1, 2017

Related U.S. Application Data
(63) Continuation of application No. PCT/EP2015/067515, filed on Jul. 30, 2015.

(30) Foreign Application Priority Data
Aug. 1, 2014 (EP) 14382304.5

(51) Int. Cl. B65D 81/26; A23B 7/157; C09D 177/00; B65D 85/34; B65D 25/14; B65D 43/02; B65D 43/16; A23L 31/00; B65D 21/02

(52) U.S. Cl. CPC B65D 81/266; A23L 31/00; A23B 7/157; C09D 177/00; B65D 21/0219; B65D 25/14; B65D 43/0204; B65D 43/162; B65D 85/34; A23V 2002/00; C08K 3/16

(57) ABSTRACT

A package for a fresh food selected from fresh mushrooms, fruits, and vegetables. The package includes a substrate having a coating in contact with the fresh food. According to one embodiment the coating includes a hygroscopic polymer matrix, a plasticizer, and a desiccant material selected from calcium chloride, calcium oxide, potassium chloride, magnesium chloride, magnesium sulfate, ammonium chloride, sodium nitrate, citric acid, and tartaric acid, and wherein the amount of plasticizer is from 5 to 20 wt. % with respect to the amount of polymer matrix, and the amount of desiccant material is from 25 to 60 wt. % with respect to the amount of polymer matrix. Also, is provided a process for producing the package.

### CROSS-REFERENCE TO RELATED APPLICATIONS

The present application relates to and claims the benefit and priority to International Application No. PCT/EP2015/067515, filed Jul. 30, 2015, which claims the benefit and priority to European Application No. 14382304.5, filed Aug. 1, 2014. The aforementioned International and European Applications are hereby incorporated herein by reference in their entirety.

### FIELD

The present invention relates to the field of packaging. Particularly, the invention relates to a package for the conservation of fresh mushrooms, fruits and vegetables. More particularly, it relates to a package for the conservation of Agaricus spp. mushrooms.

### BACKGROUND

Agaricus bisporus is one of the most consumed species of fresh cultivated mushrooms. Whiteness and cleanliness of fresh white button mushrooms is identified by consumers as a signal of quality and freshness. Nevertheless, Agaricus spp. mushrooms in general have a very short shelf life, usually of 4-7 days after harvest. They are very sensitive to humidity levels, to microorganisms, and to physical handling, factors that may accelerate browning or development of purple blotches. Other kind of mushrooms exhibit similar problems to the Agaricus bisporus that may affect their appearance and, as a consequence, their acceptance by a potential consumer.

Several strategies has been used to preserve the freshness of mushrooms before sale, being the most common ones the use of low temperatures during their storage and distribution, and the use of modified passive atmospheres together with some additional treatment of the product, such as washing with different products or irradiation. Alternative strategies are post-harvest treatments added to active modified atmospheres.

Although the generation of a modified atmosphere is not a complex process itself, the maintenance of this atmosphere during the shelf life of the product is a challenging issue. The thin and porous epidermal structure of mushrooms results in high respiration rates which induce their deterioration immediately after harvest. Particularly, when packaged, moisture produced by mushrooms tend to condensate in the inside walls of the package and on mushroom surface. As mentioned above, white button mushrooms are very sensitive to humidity levels, as high water levels favour microbial growth and discolouration and, conversely, low water levels lead to loss of weight and undesirable textural changes.

Shahraki, M. H. et al., “Optimisation of humidity absorbers in active packaging of button mushroom by response surface methodology and genetic algorithms”, Quality Assurance and Safety of Crops & Foods, 2013, Vol. 5, pp. 227-235, discloses the use of calcium chloride as a moisture absorber in order to absorb the excess of moisture within a package destined to increase the shelf life of button mushroom during storage. Nevertheless, calcium chloride is not incorporated in the package structure, but it is packed in high moisture permeability wraps placed under or on top of the mushrooms.

US2003235664 discloses a film structure having a desiccant material incorporated therein, wherein said film structure is utilized as a package for a product that may be sensitive to the presence of moisture. So, these packages are intended to avoid the entrance of moisture from the outside, keeping the packaged product as dry as possible.

The problem of condensation of moisture inside a packaged is also extensible to the conservation of fresh fruits and vegetables in general, as when the humidity levels exceed certain values microorganisms tend to proliferate with the consequent decay of the packaged product.

Despite the large number of possible ways to treat mushrooms, taught by the prior art, the provision of packages allowing for better quality mushrooms, and also for better quality fresh fruits, and vegetables and with a higher shelf life goes on being an active field of research.

### SUMMARY OF THE DISCLOSURE

Inventors have surprisingly found that a package with a particular coating having calcium chloride allows the excess of humidity produced by respiration of fresh mushrooms being absorbed, so avoiding water drops to fall down on the surface of mushrooms. As a consequence, the use of the package of the invention allows extending shelf-life of fresh mushrooms. Thus, shelf life of fresh mushrooms, particularly edible Agaricus spp. mushrooms, and more particularly Agaricus bisporus, can be increased until at least 12 days during storage.

The package of the invention, which can also be used for providing controlled moisture inside the package, is also suitable for the conservation of fresh fruits, and vegetables, the shelf life of which is also increased.

Thus, a first aspect of the invention relates to a package for a fresh food selected from fresh mushrooms, fruits, and vegetables comprising a substrate and a coating appropriate to be in contact with the fresh food, the coating being located in the inner part of the package and comprising a hygroscopic polymer matrix, a plasticizer, and a desiccant material selected from calcium chloride, calcium oxide, potassium chloride, magnesium chloride, magnesium sulfate, ammonium chloride, sodium nitrate, citric acid, and tartaric acid, and wherein the amount of desiccant material is from 25 to 60 wt. % with respect to the amount of polymer matrix.

Another aspect of the invention relates to a process for the preparation of the package as defined above, wherein the process comprises:
i) preparing a coating forming solution by a process comprising dissolving an hygroscopic polymer in a suitable solvent, adding a plasticizer, and adding a desiccant material selected from calcium chloride, calcium oxide, potassium chloride, magnesium chloride, magnesium sulfate, ammonium chloride, sodium nitrate, citric acid, and tartaric acid, in an amount from 25 to 60 wt. % with respect to the amount of polymer;
ii) applying the coating forming solution over the substrate used to conform the package;
iii) removing the solvent by evaporation; and
iv) conforming the package,
   wherein the coating is in the inner side of the package, and wherein step iv) can alternatively be carried out before step ii).

Still another aspect of the invention relates to a method for the conservation of a fresh food selected from fresh mushrooms, fruits, and vegetables comprising putting the fresh food inside the package as defined above, wherein the maximum surface of the fresh food is in contact with the inner surface of the package.

### BRIEF DESCRIPTION OF THE DRAWINGS

FIG. 1 shows a package for the conservation of mushrooms comprising an opaque tray 1 and a transparent lid 2 (FIG. 1a), as well as a detailed section of the closing system by the use of four protruding buttons 3 on the lid that are inserted in the corresponding hollows 4 on the upper part of the tray (FIG. 1b.

FIG. 2 shows the section of a package with or without lid and the distribution of the mushrooms in the package of the invention; Details of the support between the lid and the tray are shown.

FIG. 3 shows a package for the conservation of mushrooms comprising two pieces, namely a tray and a lid,

FIG. 4 shows a single piece package for the conservation of mushrooms wherein the lid is built-in with the tray.

FIG. 5 shows a lid 2 over which the tray 1 of an upper packaged is stacked (FIG. 5a), and an enlarged detail of the system limiting the movement of the tray stacked on a lid of the package underneath (FIG. 5). The system used to set the position in the stack is a mark or peripheral nerve 5 on the lid that limits the movement of the tray stacked on it by providing a support for the base thereof (FIG. 5b).

FIG. 6 shows the evolution of the contact angle on both sides of the drop. Mean and standard deviation are depicted.

FIG. 7 shows images of the drop during the measurements, at the beginning (t=0 min) and at the end (t=30 min) of the test.

FIG. 8 shows the selection of the caps of one of the mushroom samples (package containing five mushrooms) by the software Image J.

FIG. 9 shows the evolution in time of mushrooms in a) a package comprising a tray (1) and an lid (2), wherein the height of the package is adapted to allow the maximum surface of the fresh mushrooms being in contact with the inner surface of the package, wherein the lid (2) is coupled to the tray (1) in such a way that allows the breathing of the mushroom, and wherein the edges and corners of the packaged are rounded to allow the mushrooms being placed inside without being damaged, namely, a package without coating (blank); b) the package as defined in a) with a coating without CaCl₂ (blank+PA); c) a package of the invention, namely the package as defined in a) with a coating with CaCl₂ (3.5%) (Blank+PA+CaCl₂ (3.5%)); d) a package of the invention, namely the package as defined in a) with a coating with CaCl₂ (5%) (Blank+PA+CaCl₂ (5%)), with 3 samples each during 12 days of test. Percentage of calcium chloride is with respect to the sum of the amounts of the solvent system, glycerol and polyamide.

FIG. 10 shows the evolution in time of mushrooms in a) batch 1: a package without coating (blank, standard polyethylene terephthalate tray); b) batch 2: a package comprising a tray (1) and an lid (2), wherein the height of the package is adapted to allow the maximum surface of the fresh mushrooms being in contact with the inner surface of the package, wherein the lid (2) is coupled to the tray (1) in such a way that allows the breathing of the mushroom, and wherein the edges and corners of the packaged are rounded to allow the mushrooms being placed inside without being damaged; c) batch 3: a package of the invention, namely a package as in batch 2 but with a coating with CaCl₂ (3.5%) as defined herein. Percentage of calcium chloride with respect to the sum of the amounts of the solvent system, glycerol and polyamide.

FIG. 11 shows the capacity to absorb water of coatings containing a desiccant (35 wt. % CaCl₂ with respect to polymer) and a variable amount of plasticizer (glycerol).

### DETAILED DESCRIPTION

The term “corona treatment”, as used herein, refers to a surface modification technique that uses a low temperature corona discharge plasma to impart changes in the properties of a surface, in this case the surface of a packaging material, so that it became more adherent.

The term “solvent suitable for food contact”, as used herein refers to any solvent that can be used safely in the manufacture of plastics and other materials which come into contact with food for human consumption. The solvent must be harmless and devoid of any toxic properties. The term “solvent system” as used herein refers either to a single solvent or to a mixture of solvents.

The term “coating forming solution”, as used herein, relates to a solution of the components finally forming the coating that, after the removal of the solvent system, yield a coating.

The term “interspersed in the polymeric matrix”, as used herein, means that the substance to which it relates, namely the plasticizer and/or the calcium chloride, is at least in part distributed and scattered inside the polymer matrix, so that it is mainly not in direct contact with the mushrooms.

Generally the maximum surface of the fresh mushrooms, fruits or vegetables being in contact with the inner surface of the package” is that where the foodstuff is in contact with the inner surface of all the faces of the package, including the lid.

As used herein, a material that is described as “disposed over” an indicated substrate refers to a coating deposited in at least a portion of the surface of the substrate. As used herein, the term “coating” refers to one or more layers deposited on a substrate.

The term “contact angle”, as used herein, refers to the angle, conventionally measured through the liquid, where a liquid/vapour interface meets a solid surface. It quantifies the wettability of a solid surface by a liquid.

The term “wt. %” or “percentage by weight”, as used herein, of a component, as used herein, means the amount of the single component relative to the total weight of the composition or, if specifically mentioned, of other component.

As commented above, a first aspect of the invention relates to a package for fresh mushrooms, fruits, and vegetables comprising a substrate and a coating located in the inner part of the package and comprising a hygroscopic polymer matrix, a plasticizer, and a desiccant material selected from calcium chloride, calcium oxide, potassium chloride, magnesium chloride, magnesium sulfate, ammonium chloride, sodium nitrate, citric acid, and tartaric acid, or its combinations and wherein the amount of desiccant material is from 25 to 60 wt. %, particularly from 35 to 55 wt. %, with respect to the amount of polymer matrix.

In a particular embodiment, optionally in combination with one or more features of the particular embodiments defined above or below, the desiccant material is calcium chloride. Particularly, the amount of calcium chloride is from 35 to 55 wt. %, with respect to the amount of polymer matrix, more particularly from 35 to 45 wt. %, more particularly 38 wt. %, or 39 wt. %, or 50 wt. % with respect to the amount of polymer matrix.

In another particular embodiment, optionally in combination with one or more features of the particular embodiments defined above or below, the plasticizer and the desiccant material, particularly the calcium chloride, are interspersed in the polymeric matrix.

The coated surface provides a low contact angle, which means a water drop is extended more than without the coating, and so water is better able to wet the inner surface of the package. Contact angle can be measured by the video-based optical contact angle measuring system OCA 15plus (NEURTEK) with dosing system, as can be seen in example 2 below.

Accordingly, in a particular embodiment of the package of the invention, optionally in combination with one or more features of the particular embodiments defined above or below, the contact angle of the coated surface after 30 min is from 10° to 55°, particularly from 20° to 40°.

In another particular embodiment, optionally in combination with one or more features of the particular embodiments defined above or below, the polymer matrix is formed by a hygroscopic polymer having a good adhesiveness with the substrate, and, at the same time, allowing the desiccant material, particularly calcium chloride, to retain its capacity to absorb moisture when it is interspersed in the polymeric matrix. In another particular embodiment, optionally in combination with one or more features of the particular embodiments defined above or below, the hygroscopic polymer is selected from the group consisting of a polyamide (PA), acrylonitrile butadiene styrene (ABS), polyethylene terephthalate (PET), polycarbonate (PC), and polylactic acid (PLA). Particularly, the polymer is a polyamide. More particularly, the polyamide is selected from PA 6, PA66, PA6/66, PA610, PA612, PA11, PA12, and PA 6I/6T.

Polyamide 6 (PA6) is prepared by ring-opening polymerization of caprolactam; polyamide 66 (PA66) is prepared by polycondensation of hexamethylenediamine and adipic acid; polyamide 6/66 (PA6/66) is prepared by polycondensation of caprolactam, hexamethylendiamine, and adipic acid; polyamide 610 (PA610) is prepared by polycondensation of hexamethylene diamine and sebacic acid; polyamide 612 (PA612) is prepared by polycondensation of an equivalent mixture of hexamethylenediamine and 1,12-dodecanedioic acid; polyamide 11 (PA11) is prepared by polycondensation of w-aminoundecanoic acid, while; polyamide 12 (PA12) is obtained by ring-opening polymerization of laurolactam; and polyamide 6I/6T (PA 6I/6T) is prepared by polycondensation of hexene diamine and terephthalic and isophtalic acid. As an example, polyamide 6/66/136, a polyamide 6/66, is commercialized by Basf under the trademark of Ultramid® 1C.

The substrate can be a polymer selected from polyethylene terephthalate (PET), polyethylene (PE), polypropylene (PP), Polystyrene (PS), polyvinyl chloride (PVC) and Polylactic acid (PLA). In a particular embodiment, optionally in combination with one or more features of the particular embodiments defined above or below, the substrate is polyethylene terephthalate (PET).

In another particular embodiment, optionally in combination with one or more features of the particular embodiments defined above or below, the amount of plasticizer is from 5 to 20 wt. %, particularly from 7.5 to 15 wt. %, more particularly of a 10 wt. %, with respect to the amount of polymer matrix. Examples of plasticizers include, but are not limited to, glycerol, polyethylene glycol, propylene glycol, tert-butylcitrate, and polyadipate. Preferably, the plasticizer is glycerol.

The use of glycerol as plasticizer, together with the action of the desiccant material, particularly with calcium chloride, as moisture absorber is effective in decreasing the contact angle formed between a water drop and the surface of the coated substrate at predetermined times. This is advantageous in that it eases the wetting of the inner coated surface of the package, and so the capacity of the coating to absorb moisture is increased. This facilitates the removal of the excess of humidity in the interior of the package. When glycerol and calcium chloride are used the effect is particularly effective.

In a particular embodiment, optionally in combination with one or more features of the particular embodiments defined above or below, the amount of coating in the package is from 0.1 to 0.4 g for every 150 g of fresh mushrooms, fruits, or vegetables, particularly of fresh mushrooms. More particularly the amount of coating is from 0.2 g for every 150 g of Agaricus bisporus.

In another particular embodiment, optionally in combination with one or more features of the particular embodiments defined above or below, the thickness of the coating in the package as defined above is from 3 to 15 μm, particularly 4 μm to 9 μm, and more particularly 5 μm to 6 μm.

Embodiments of the present invention encompass packages in which the coating, or materials included therein such as the hygroscopic polymer, the plasticizer or calcium chloride, are not covalently bound or chemically bound to the surface of the substrate to which the coating is applied.

The package of the invention is suitable for preserving fresh mushrooms, fruits, and vegetables. In a preferred embodiment, optionally in combination with one or more features of the particular embodiments defined above or below, the package of the invention is suitable for preserving fresh mushrooms. It is particularly suitable for preserving edible mushrooms of the genus Agaricus spp. such as Agaricus bisporus, Agaricus Bitorquis, Agaricus campestris, Agaricus blazei, and Agaricus arvensis, more particularly, of Agaricus bisporus. The package is suitable for entire mushrooms or laminated mushrooms.

Accordingly, a particular embodiment, optionally in combination with one or more features of the particular embodiments defined above or below, encompasses a package for fresh mushroom comprising a substrate and a coating appropriate to be in contact with fresh mushroom, the coating being located in the inner part of the package and comprising a polymer matrix, a plasticizer, and calcium chloride, wherein the plasticizer and the calcium chloride are interspersed in the polymeric matrix, and wherein the amount of calcium chloride is from 25 to 60 wt. %, particularly from 35 to 55 wt. %, more particularly 38 wt. %, or 39 wt. %, or 50 wt. %, with respect to the amount of polymer matrix.

Preferably, the coating in the package is intended to be in contact with the mushrooms when these are packaged. More preferably, the coating in the package is in contact with the mushroom caps, or at least with the maximum number of mushroom caps, and with the lower part of mushroom stem, or at least with the maximum number of mushroom caps.

The package of the invention is also suitable for the conservation of fresh fruits and vegetables that are sensitive to humidity, namely whose shelf life is directly related with the control of humidity. In a particular embodiment, the package of the invention is for a fresh food selected from the group consisting of strawberry, raspberry, blackberry, blueberry, and cranberry.

The structural design of the package can also play a role in the conservation of fresh mushrooms, fruits, and vegetables.

Advantageously, the package of the invention allows:
protecting the product from possible damage during the distribution cycle and keep the product immobilized during transport;
protecting the top of the product, particularly of mushrooms, to avoid damage (marking) the product by pressure;
allow product respiration;
keeping the product in contact with the coating;
avoiding lateral pressure of the container on the product, as well as tight edges or angles that may damage the product;
allow the order of the product inside the package;
be reclosable and allow the protection of the product after opening during its life cycle;
be transparent or opaque, in one or in two pieces, depending on the applications;
be adapted to the distribution system, for maximum logistics optimization;
be adapted to the thermoforming manufacturing, with different angles of output across nerves or details of the package;
having a large area, both in the base and the upper part or lid, so that the coating comes into contact with the product; and
allow nesting of the container for storage and transport prior to packaging.

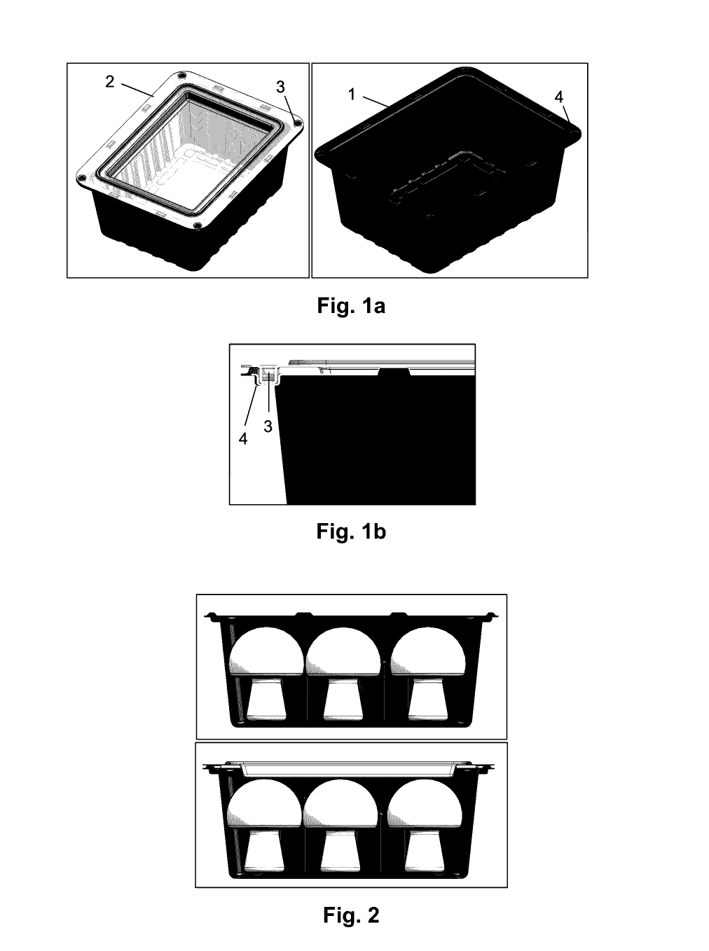

FIGS. 1 to 5 depict an embodiment of the package of the invention, particularly for the conservation of fresh mushrooms (Agaricus bisporus).

A particular embodiment is illustrated in FIG. 1, wherein a complete package (FIG. 1a) comprising an opaque tray 1 and a transparent lid 2 is shown. The closing system of the package can be made up of four protruding buttons 3 on the lid that are inserted in the corresponding hollows 4 on the upper part of the tray, as shown in FIG. 1b.

Preferably, the mushrooms are in contact with the coating, being the contact surface as higher as possible. So, the packaged is designed so that the inner side of the lid is in contact with the maximum number of mushroom caps, and the inner part of the bottom of the tray is in contact with the base of the mushrooms. The side walls of the tray are also in contact with the product, due to rounding or corners which allow for maximum contact. FIG. 4 illustrates a particular embodiment of a detail on how the lid is placed on the tray.

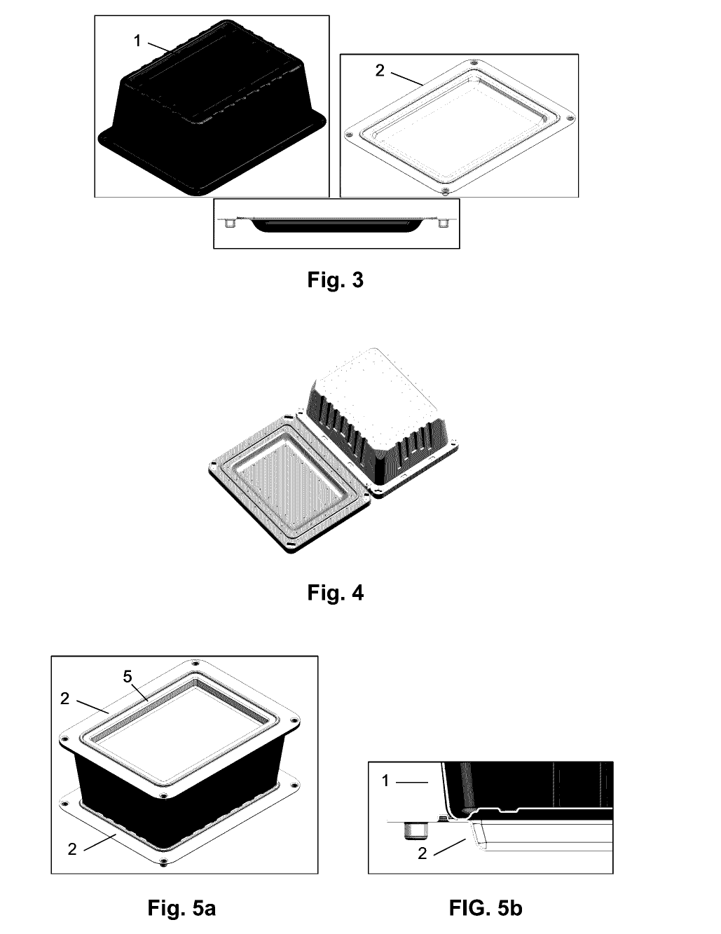

The package of the invention can comprise two pieces, namely a tray and a lid (FIG. 3). Optionally, the lid can be built-in with the tray forming a single piece (FIG. 4).

In a particular embodiment, the system used to set the position in a stack is a mark or peripheral nerve 5 on the lid 2 that limits the movement of the upper tray 1 (of the package above) stacked on it, providing a support for the base of the package (FIGS. 5a and 5b).

The lid is adapted to the tray so that breathing of the food product inside is allowed without the need to punch the package. Additionally, the edges and corners of the packaged are rounded so that the product can be placed inside without being damaged.

The package is also design to ease the nesting of the container for storage and transport prior to packaging.

In a particular embodiment, optionally in combination with one or more features of the particular embodiments defined above or below, the package of the invention for the conservation of fresh mushrooms, fruits or vegetables comprises a tray 1 and an lid 2, wherein the height of the package is adapted to allow the maximum surface of the fresh mushrooms, fruits or vegetables being in contact with the inner surface of the package; wherein the lid is coupled to the tray in such a way that allows the breathing of the mushroom; and wherein the edges and corners of the packaged are rounded to allow the mushrooms, fruit or vegetables being placed inside without being damaged.

In a more particular embodiment, the package is for the conservation of fresh mushrooms, particularly of Agaricus bisporus, has a height from 50 mm to 90 mm, particularly of 72 mm. In a still more particular embodiment, the lid has a length of up to 190 mm and a width of up to 150 mm.

When the package is intended for fresh fruits or vegetables, the height of the package is adapted so that the maximum surface of the fresh fruit or vegetable is in contact with the inner surface of the package.

As commented above, the package of the invention can be prepared by a process comprising i) preparing a coating forming solution; ii) applying the coating forming solution over a polymeric substrate; iii) removing the solvent by evaporation; and iv) conforming the package, wherein step iv) can alternatively be carried out before step ii).

In a particular embodiment, optionally in combination with one or more features of the particular embodiments defined above or below, the coating is formed before the packages are conformed, namely, steps ii) and iii) are carried out before step iv).

A typical manufacturing process for coating a substrate is dissolving the polymer forming the polymer matrix, the plasticizer, and the desiccant material as defined above, particularly calcium chloride, in a solvent system (a fluid), and disposing the resulting coating solution over the substrate by procedures such as impression, spraying, or extension of the solution over the substrate. Such coating procedures are well-known in the art. In a particular embodiment, the calcium chloride is interspersed in the polymeric matrix once the coating is formed.

The suitable solvent system is a solvent suitable for food contact or a mixture of solvent suitable for food contact. In a particular embodiment, the solvent is selected from ethyl acetate, isopropanol, 1-propanol, water, and combinations thereof. Particularly, the solvent is a mixture of water and isopropanol, more particularly a mixture of water:isopropanol 1:4.

Particularly, the coating can be prepared by a process comprising:
i) dissolving the hygroscopic polymer forming the polymer matrix in a suitable solvent system, adding a plasticizer, and adding a desiccant material selected from calcium chloride, calcium oxide, potassium chloride, magnesium chloride, magnesium sulfate, ammonium chloride, sodium nitrate, citric acid, and tartaric acid, particularly calcium chloride, in an amount from 25 to 60 wt. % with respect to the amount of polymer in order to get a solution;
ii) disposing the coating solution over the substrate used to conform a package, preferably by extension of the solution over the substrate; and
iii) removing the solvent by evaporation, such as with the application of an air current, heating or vacuum, preferably by an air current, to yield a coating (solid layer comprising the substances dissolved in the coating solution) on the substrate.

In general, the coating can be applied to a surface of the substrate, which will be the surface forming the inner surface of a package for the conservation of the fresh food, such as mushrooms, that is the surface in contact with the fresh food.

As commented above, an aspect of the invention relates to a process for the preparation of the package as defined above, wherein the process comprises:
i) preparing a coating forming solution by a process comprising dissolving an hygroscopic polymer in a suitable solvent, adding a plasticizer, and adding a desiccant material selected from calcium chloride, calcium oxide, potassium chloride, magnesium chloride, magnesium sulfate, ammonium chloride, sodium nitrate, citric acid, and tartaric acid in an amount from 25 to 60 wt. % with respect to the amount of polymer;
ii) applying the coating forming solution over the substrate used to conform the package;
iii) removing the solvent by evaporation, such as with the application of an air current, heating or vacuum, preferably by an air current, to yield a coating on the substrate; and
iv) conforming the package,
   wherein the coating is in the inner side of the package, and wherein step iv) can alternatively be carried out before step ii).

In a particular embodiment, optionally in combination with one or more features of the particular embodiments defined above or below, the desiccant material is calcium chloride. Particularly, the amount of calcium chloride is from 35 to 55 wt. %, with respect to the amount of polymer matrix, more particularly 38 wt. %, or 39 wt. %, or 50 wt. % with respect to the amount of polymer matrix.

In a particular embodiment, optionally in combination with one or more features of the particular embodiments defined above or below, the coating forming solution consists of:
a 10 wt. % of polyamide with respect to the amount of the solvent system;
a solvent system which is a mixture of isopropanol:water (1:4);
a 10 wt. % of glycerol with respect to the amount of polymer;
a 3.5 wt. % of calcium chloride with respect to the sum of the amounts of the solvent system, glycerol and polyamide.

The use of this specific combination of components allows obtaining a package with a higher weight per surface area unit.

Preferably, removal of the solvent is carried out by air current in order to get a more transparent film.

Previously to the application of the coating, the surface of the polymeric substrate can be modified to get a maximum adherence of the later in order to assure the stay of the coating during the shelf-life of the product.

The modification of the substrate surface can be carried out by techniques such as removal of the demoulding oil with ethanol, corona treatment, or a combination there both. Preferably, the modification of the substrate surface is carried out by corona treatment. Accordingly, in a particular embodiment, step ii) of the process for the preparation of the package of the invention as defined above can comprise the steps of:
a) applying a corona treatment to the polymeric substrate to be coated; and
b) applying the coating forming solution to the treated polymeric substrate by impression, spraying, or extension to form a polymeric coating.

It is also part of the invention the package of the present invention obtainable by the process defined above, including any one of the particular embodiments mentioned above or below.

As commented above, the invention also relates to a method for the conservation of a fresh food selected from fresh mushrooms, fruits, and vegetables by the use of the package of the invention wherein the maximum surface of the fresh food is in contact with the inner surface of the package.

In a particular embodiment, optionally in combination with one or more features of the particular embodiments defined above or below, the fresh food is a fresh mushroom and the maximum number of mushroom caps is in contact with the coating on the inner side of the lid and on the side walls of the package, and the bases of the mushroom's stems are in contact with the coating on the base of the package.

In a more particular embodiment, the fresh food is an edible mushroom of the genus Agaricus spp., the amount of mushrooms contained by the package is of 1.5-2 g/cm² of base of base of the package (namely of 100-300 g per package), and the shelf life of the mushrooms is maintained until at least 12 days during storage. More particularly, the mushroom is Agaricus bisporus.

By the use of the method of the invention, shelf life of fresh mushrooms, particularly edible Agaricus spp. mushrooms, and more particularly Agaricus bisporus, can be increased from 5 to 9 extra days, or even more (see Example 4 where mushrooms conserved their good appearance after 19 days).

Additionally, the invention also relates to a method for the conservation of fresh food selected from fruits and vegetables, method comprising putting the fresh food inside the package as defined above wherein the fresh food is in contact with the coating on the lid, on the sides, and on the base of the package.

Throughout the description and claims the word “comprise” and variations of the word, are not intended to exclude other technical features, additives, components, or steps. Furthermore, the word “comprise” encompasses the case of “consisting of”.

Additional objects, advantages and features of the invention will become apparent to those skilled in the art upon examination of the description or may be learned by practice of the invention.

The following examples and drawings are provided by way of illustration, and they are not intended to be limiting of the present invention.

Furthermore, the present invention covers all possible combinations of particular and preferred embodiments described herein.

### EXAMPLES

### Example 1

### Preparation of a Coating Forming Solution

In 100 g of a mixture of water:isopropanol (1:4), 10 g of polyamide Ultramil 1C were dissolved at 60° C. Once the polymer was dissolved, an amount of 1 g of glycerol and 3.88 g of CaCl₂ (formulation 1) or 5.55 g of CaCl₂ (formulation 2) were added in order to obtain a polymer coating forming solution.

In a mixture of water:isopropanol (1:4), a 10 wt. % of Ultramil 1C was dissolved at 60° C. Once the polymer was dissolved, an amount of a 10 wt. % of glycerol with respect to the amount of polymer and a 3.5 wt. % of CaCl₂ with respect to the sum of the amounts of the solvent system, glycerol and polymer (formulation 1) or a 5 wt. % of CaCl₂ with respect to the sum of the amounts of the solvent system, glycerol and polymer (formulation 2) were added in order to obtain a polymer coating forming solution. The following table shows the assayed formulations.

TABLE 1

| | | | | CaCl₂ (wt. % with |
|---|---|---|---|---|
| | | | | respect to the sum |
| | | PA (wt. %) | glycerol | of the amounts of |
| | | with respect | (wt. % with | the solvent system, |
| | Formulation | to solvent | respect to | glycerol and |
| No. | (solution) | system | polymer) | polymer) |
| 1 | Blank | — | — | — |
| 2 | Blank + PA 1 | 10 | 10 | — |
| 3 | Blank + PA + | 10 | 10 | 3.5 |
| | CaCl₂ (3.5%) | | | |
| 4 | Blank + PA + | 10 | 10 | 5 |
| | CaCl₂ (5%) | | | |

### Manufacture of the Containers

A PET substrate in form of a 450 μm film was obtained. After removing with ethanol the demoulding oil remaining on their surface, the film was submitted to a corona treatment by a high frequency electron gun (Electrotechnic, Product Inc., Chicago, EEUU).

Thereafter, each one of the formulations (solutions) shown in Table 1 were extended over PET films by a Elcometer 4340 (Elcometer Limited) coating machine, using a 50 μm bar. The coated films were left to dry for 4 hours. Finally they were shaped in the form of packages.

Approximately 150 g of fresh mushrooms were packed in each one of the packages.

### Example 2—Measurement of the Contact Angle

To measure the contact angle, the video-based optical contact angle measuring system OCA 15plus (NEURTEK) with dosing system was used. The experiment involved spilling a drop of water on the substrate to be evaluated. The instrument measured the contact angle formed between the drop and the surface at predetermined times. The lower the contact angle the more extended is the drop, which means that water is better able to wet the surface and less droplets capable of damaging the mushrooms will be formed on the surface of the package.

Experimental Conditions:

Liquid of the drop: Water (HPLC grade)

Dosing system: 10 mL syringe at a height of 2 cm

Measurement time: 0 and 30 min

### Results

Samples of a PET substrate either uncoated or coated with different coating forming solutions were prepared.

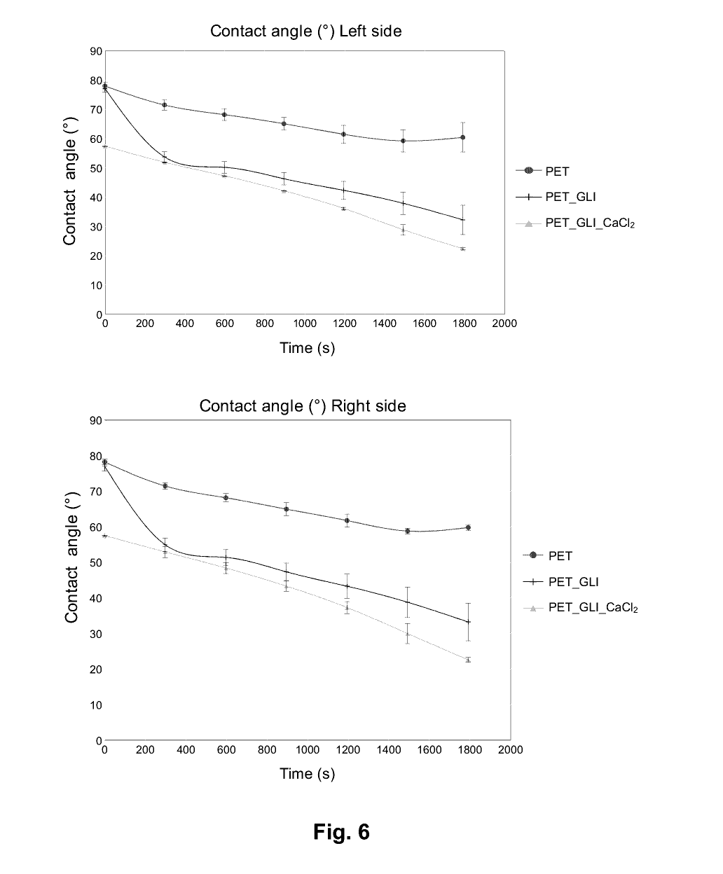

In FIG. 6 the evolution of the contact angle on both sides of the droplet (2 replicates per type of coating) is shown. Table 2 shows the mean values of the replicates measures, including measures on both sides of the drop at the beginning and at the end of the test for each one of the samples assayed.

TABLE 2

Contact angle θ°

| Sample | t = 0 min | t = 30 min |
|---|---|---|
| PET | 75 ± 3 | 59 ± 2 |
| PET_GLI⁽¹⁾ | 78 ± 1 | 33 ± 4 |
| PET_GLI_CaCl₂⁽²⁾ | 60 ± 4 | 22.5 ± 0.5 |

⁽¹⁾PET_GLI stands for PET + PA + glycerol;
⁽²⁾PET_GLI_CaCl₂ stands for PET + PA + glycerol + CaCl₂ (3.5%)

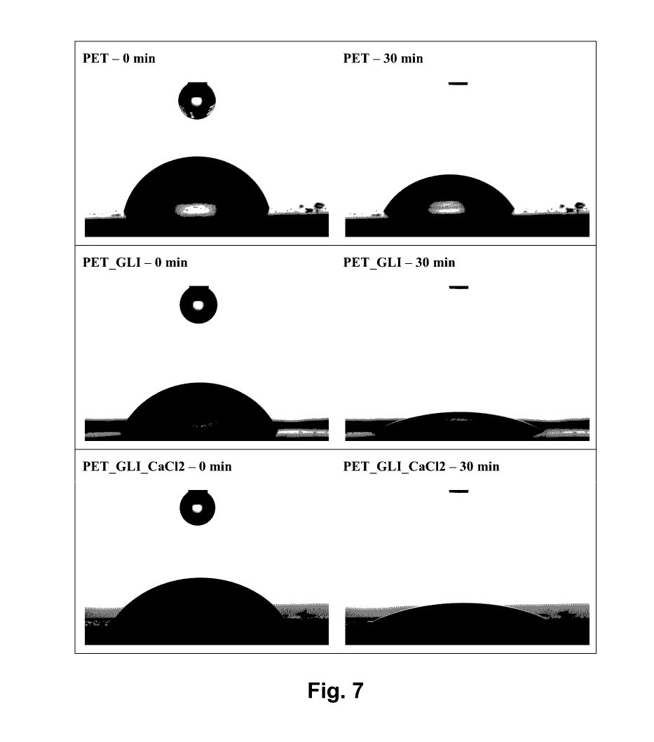

As can be seen, the sample formed by the PET substrate coated with a solution comprising a 10 wt. % of polyamide Ultramil 1C (PA) and a 10 wt. % of glycerol (GLI) with respect to the amount of polymer, gave a contact angle of 330±40 versus the 590±20 value obtained for the PET substrate without coating. When CaCl₂ is incorporated in the coating the contact angles is even lower, down to 23°. Images of the drop during the measurements at the beginning (t=0 min) and at the end (t=30 min) of the test are shown in FIG. 7.

So, the combined use of a plasticizer (particularly, glycerol) and CaCl₂ boost the decrease of the contact angle, which is beneficial for the water absorption by the coating.

Additionally, surface-tension of the surface measured at room temperature (23° C.) and a 50% of HR passed from 22 mN/m of the untreated surface to 48 mN/m of the treated surface.

The surface-tension was measured by the video-based optical contact angle measuring system OCA 15plus (NEURTEK) with dosing system.

### Example 3—Assessment of the Mushroom Colour

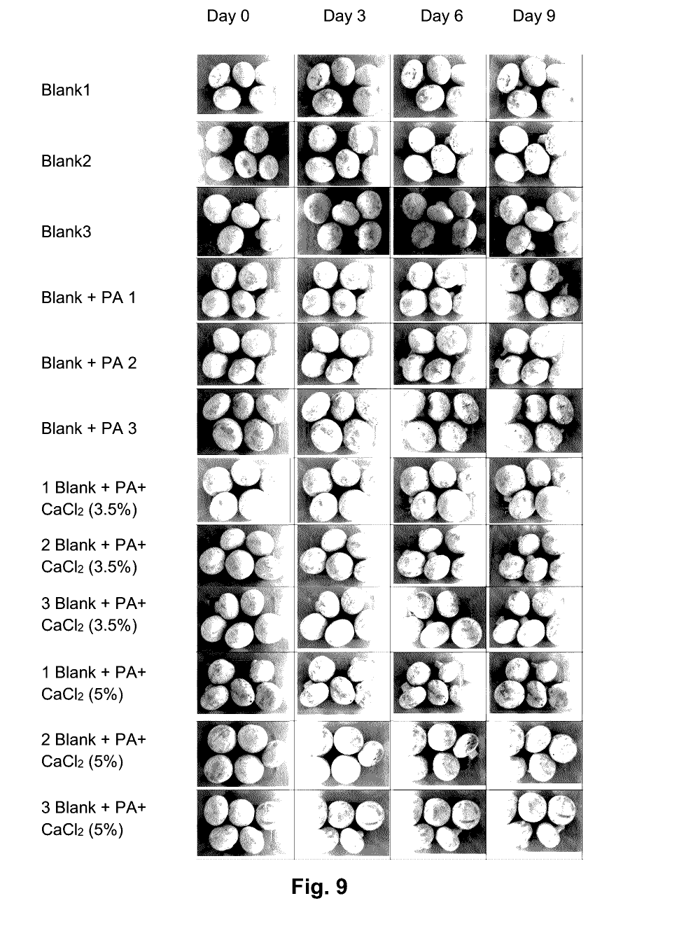

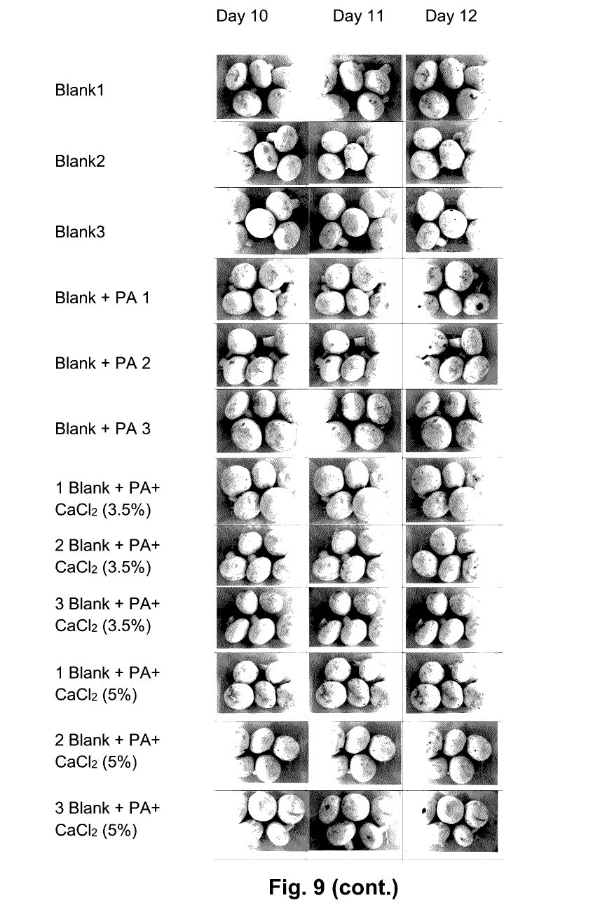

Samples were prepared in single piece PET packages with a lid built-in with the tray, and with a coating disposed over the inside surface of the package by the application of the coating forming solution as disclosed in Example 1 comprising either 3.5 wt. % of CaCl₂ (rows 7-9 of FIG. 9) or 5% w/v of CaCl₂ (rows 10-12 of FIG. 9). Each package (sample) contained about 150 g of Agaricus bisporus (five mushrooms of 30-50 mm caliber, i.e. of cap diameter, and of 20-50 g each) vertically arranged in an upright position. Caps of the mushrooms, as well as bases of the stems, were in contact with the coating of the package

As a reference, for the sake of comparison, three blanks with PET packages without coating (rows 1-3 of FIG. 9) and tree blanks of PET packages with a coating of glycerol and polyamide (coating without CaCl₂; rows 4-6 of FIG. 9) were prepared.

Determination of colour of the mushrooms by image analysis was performed both by visual inspection and using a specialized tool for measuring colour. Although visual inspection is more robust, it has always an element of subjectivity in the analysis, so it is advisable to work with both in parallel.

Firstly, photographs were taken in the laboratory by maintaining the following parameters:

| | |
|---|---|
| Ambient light | Light area where photos are made: off |
| Package | Top and side hole on opposite sides |
| Camera and conditions | Canon 1100D |
| | Manual Position |
| | Focal length 18 |
| | ISO 800 |
| | Diaphragm ⅛ |
| | Speed 1/250 |

For visual inspection all references were organized in a single panel. The different references were marked in the rows and the days where the product was analysed were marked on the columns (see FIG. 9). The findings of this trial are presented in the results section.

Change in colour of the product was analysed using the software Image J 1.47v (Free software for images treatment). as a complementary examination. Thus, for each of the samples, containing five mushrooms each, RGB colour parameters of two mushrooms (2 caps) were obtained. During the life of the product the same mushrooms were analysed to determine the evolution.

Subsequently, CIElab system coordinates were obtained with the software easyRGB Color Search Engine (http://easyrgb.com/). From the values obtained of parameters L* (bright/dark), a * (green/red), and b * (blue/yellow), the total color change was obtained by the following equation (J.

Lukinac, et al., “An application of image analysis and colorimetric methods on color change” Agric. Conspec. Sci., 2009, Vol. 74, pp. 233-237):

ΔE=\sqrt{(L*−Li)²+(a*−ai)²+(b*−bi)²}

wherein, L* is bright/dark), a* is green/red, b* is blue/yellow, and Li, ai, and bi are the values obtained at the beginning of the shelf-life (day 0).

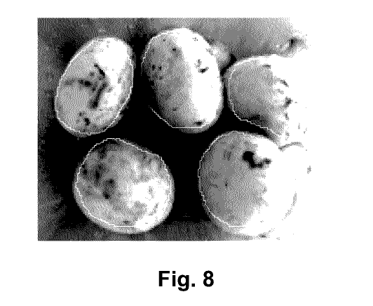

Moreover, browning of the five mushrooms of each sample was analysed by valuing the increased grey level. For this test, work was carried out with the image in 8 bits (grey scale) and the difference in grey level between day 0 and day 12 was taken as data, averaging all selected pixels. The mode selection on one of the samples is shown in FIG. 8. Only caps of the mushrooms were selected, avoiding the selection of the cap borders so that shadows are not confused with browning values.

### Results

FIG. 9 shows the complete set of samples and test days. For assessing the variation of the colour obtained by the software mentioned above all the samples were used. For the visual analysis three intermediate columns were discarded in order to simplify the survey, namely only columns corresponding to days 0, 6, 9, 11, and 12 were used.

The samples show a lower number of dark blotches in mushrooms in contact with packages with coatings comprising CaCl₂ than in mushrooms in packages without coating or with a coating without CaCl₂. Additionally, mushrooms in the packages of the invention conserved their good appearance after 12 days (when the assay was finished).

### Example 4

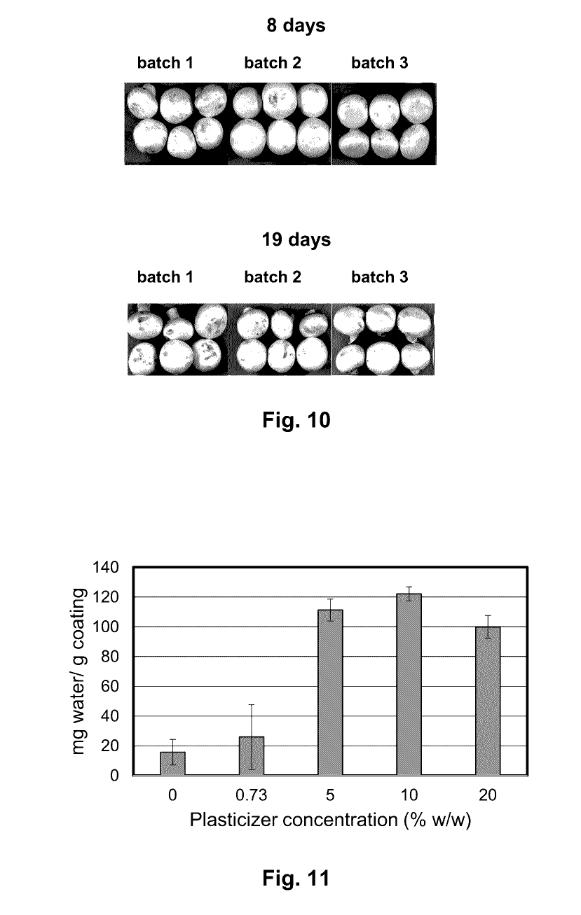

An assay carried out as in Example 3, but wherein the coating of the packages of the invention were obtained from a coating forming solution comprising 3.5 wt. % of CaCl₂. FIG. 10 shows the complete set of samples and test days. The assessment of the variation of the colour was made as in Example 3.

The period of assessment was extended until 26 days. Mushrooms conserved their good appearance after 18 days.

### Examples 5 to 7 and Comparative Examples 1 to 2

### Preparation of a Coating Forming Solution

In 1 L of a mixture of water:isopropanol (1:4), 83 g of polyamide Ultramil 1C were dissolved at 60° C. Once the polymer was dissolved, different amounts of glycerol and a fixed amount of CaCl₂ were added in order to obtain a polymer coating forming solution. The corresponding comparative examples without adding either CaCl₂ or glycerol were also carried out.

The following table shows the assayed formulations:

TABLE 3

| | | glycerol |
|---|---|---|
| | CaCl₂ (wt. % | (wt. % with |
| | with respect to | respect to |
| No. | polymer) | polymer) |
| Comparative | 35 | 0 |
| Example 1 | | |
| Comparative | 35 | 0.73 |
| Example 2 | | |
| Example 5 | 35 | 5 |
| Example 6 | 35 | 10 |
| Example 7 | 35 | 20 |

### Sample Preparation

1 g of each polymer coating forming solution was spread onto a Petri dish and dried at 60° C. overnight to obtain the corresponding coating.

### Isotherm Method

Once dried, the different coatings were placed into chambers at 20° C. These chambers were equilibrated to 94% relative humidity by using a saturated solution of potassium sulphate. Samples were weighed at day 6.

### Results

As shown in FIG. 11, the combination of the desiccant (CaCl₂, 35 wt. % with respect to polymer) with an amount of plasticizer (glycerol) from 5 to 20 wt. % with respect to the amount of polymer matrix provides a coating having a capacity to absorb water that is higher than expected.

### REFERENCES CITED IN THE APPLICATION

1. Shahraki, M. H. et al., “Optimisation of humidity absorbers in active packaging of button mushroom by response surface methodology and genetic algorithms”, Quality Assurance and Safety of Crops & Foods, 2013, Vol. 5, pp. 227-235.
2. US2003235664
3. J. Lukinac, et al., “An application of image analysis and colorimetric methods on color change” Agric. Conspec. Sci., 2009, Vol. 74, pp. 233-237.

What is claimed is:

1. A package for a fresh food selected from the group consisting of fresh mushrooms, fruits, and vegetables, the package comprising a substrate and a coating located inside the package on the substrate in contact with the fresh food, the coating comprising a hygroscopic polymer, a plasticizer, and a desiccant material selected from the group consisting of calcium chloride, calcium oxide, potassium chloride, magnesium chloride, magnesium sulfate, ammonium chloride, sodium nitrate, citric acid, and tartaric acid, the amount of plasticizer being from 5 to 20 wt. % with respect to the amount of the hygroscopic polymer, and the amount of desiccant material being from 25 to 60 wt. % with respect to the amount of the hygroscopic polymer.

2. The package according to claim 1, wherein the amount of plasticizer is from 5 to 15 wt. % with respect to the amount of hygroscopic polymer.

3. The package according to claim 1, wherein the amount of plasticizer is from 7.5 to 10 wt. % with respect to the amount of hygroscopic polymer.

4. The package according to claim 1, wherein the plasticizer is glycerol.

5. The package according to claim 1, wherein the desiccant material is calcium chloride.

6. The package according to claim 1, wherein the hygroscopic polymer is selected from the group consisting of a polyamide, acrylonitrile butadiene styrene, polyethylene terephthalate, polycarbonate, and polylactic acid.

7. The package according to claim 6, wherein the hygroscopic polymer is a polyamide.

8. The package according to claim 1, wherein the coating has a thickness in a range from 3 to 15 μm.

9. The package according to claim 1, wherein the fresh food is an edible mushroom of the genus Agaricus spp.

10. The package according to claim 1 having an inner surface and comprising a tray and a lid,
wherein the package has a height which is adapted to allow a maximum surface of the fresh mushrooms, fruits or vegetables being in contact with the inner surface of the package;
wherein the lid is coupled to the tray in such a way that allows the breathing of the fresh mushroom, fruits or vegetables; and
wherein the package has edges and corners which are rounded to allow the mushrooms, fruit or vegetables being placed inside without being damaged.

11. A method for the preparation of a package for housing fresh food selected from the group consisting of fresh mushrooms, fruits, and vegetables, the package comprising a substrate, wherein the method comprises:
i) preparing a coating forming solution by dissolving a hygroscopic polymer in a suitable solvent, adding a plasticizer in an amount from 5 to 20 wt. % with respect to the amount of hygroscopic polymer, and adding a desiccant material selected from the group consisting of calcium chloride, calcium oxide, potassium chloride, magnesium chloride, magnesium sulfate, ammonium chloride, sodium nitrate, citric acid, and tartaric acid, in an amount from 25 to 60 wt. % with respect to the amount of hygroscopic polymer;
ii) applying the coating forming solution over the substrate used to form the package;
iii) removing the solvent by evaporation to form a coating; and
iv) after step iii) or before step ii) shaping the substrate to form the package.

12. The method according to claim 11, wherein the hygroscopic polymer is a polyamide and the coating forming solution consists of:
a solvent which is a mixture of one part isopropanol to four parts water;
a 10 wt. % of polyamide with respect to the amount of the solvent;
a 10 wt. % of glycerol with respect to the amount of the hygroscopic polymer;
a 3.5 wt. % of calcium chloride with respect to the sum of the amounts of the solvent, glycerol and polyamide.

13. The method according to claim 11, wherein step ii) comprises:
a) applying a corona treatment to the substrate to be coated;
b) applying the coating forming solution to the substrate by lamination, impression or spraying to form a coating;
c) drying the coating with an air current, heat or vacuum.

14. A method for the conservation of a fresh food selected from fresh mushrooms, fruits, and vegetables comprising putting the fresh food inside a package, the package having an inner surface and comprising a substrate and a coating located inside the package onto the substrate in contact with the fresh food, the coating comprising a hygroscopic polymer, a plasticizer, and a desiccant material selected from the group consisting of calcium chloride, calcium oxide, potassium chloride, magnesium chloride, magnesium sulfate, ammonium chloride, sodium nitrate, citric acid, and tartaric acid, and the amount of plasticizer being from 5 to 20 wt. % with respect to the amount of polymer matrix, and the amount of desiccant material being from 25 to 60 wt. % with respect to the amount of polymer matrix,
wherein a maximum surface of the fresh food is in contact with the inner surface of the package.

15. The method according to claim 14, wherein the fresh food is an edible mushroom of the genus Agaricus spp., the substrate comprising a base, the amount of mushrooms contained on the package being from 1.5 to-2 g per cm² of base of the package, and the shelf life of the mushrooms being at least 12 days.

16. The package according to claim 4, wherein the desiccant material is calcium chloride.

17. The package according to claim 16, wherein the hygroscopic polymer is a polyamide.

18. The package according to claim 17 having an inner surface and comprising a tray and a lid,
wherein the package has a height which is adapted to allow a maximum surface of the fresh mushrooms, fruits, or vegetables being in contact with the inner surface of the package;
wherein the lid is coupled to the tray in such a way that allows the breathing of the fresh food; and
wherein the package has edges and corners which are rounded to allow the the fresh food to be placed inside without being damaged.

19. A process for the preparation of a package for housing fresh food selected from the group consisting of fresh mushrooms, fruits, and vegetables, the package comprising a substrate and a coating located inside the package on the substrate, wherein the process comprises:
i) preparing a coating forming solution by dissolving a polyamide in a suitable solvent, adding glycerol in an amount from 5 to 20 wt. % with respect to the amount of the polyamide, and adding calcium chloride in an amount from 25 to 60 wt. % with respect to the amount of the polyamide;
ii) applying the coating forming solution over the substrate used to form the package;
iii) removing the solvent by evaporation; and
iv) after step iii) or before step ii) shaping the substrate to form the package.

20. The process according to claim 12, wherein step ii) comprises:
a) applying a corona treatment to the substrate to be coated;
b) applying the coating forming solution to the substrate by lamination, impression or spraying to form a coating;
c) drying the coating with an air current, heat or vacuum.
